(19) United States
(12) Patent Application Publication
(10) Pub. No.: US 2013/0160022 A1
(43) Pub. Date: Jun. 20, 2013

(54) TRANSACTION MANAGER FOR NEGOTIATING LARGE TRANSACTIONS

(71) Applicants: Jeffrey Blight, Berkshire (GB); Patrick Dantressangle, Hampshire (GB); Andrew J. Osborne, Eastleigh (GB)

(72) Inventors: Jeffrey Blight, Berkshire (GB); Patrick Dantressangle, Hampshire (GB); Andrew J. Osborne, Eastleigh (GB)

(73) Assignee: INTERNATIONAL BUSINESS MACHINES CORPORATION, Armonk, NY (US)

(21) Appl. No.: 13/329,382

(22) Filed: Dec. 19, 2011

(51) Int. Cl. G06F 9/50

(52) U.S. Cl. 718/104

(57) ABSTRACT

A computer receives a transaction request that includes information identifying computer resource requirements for the transaction, a resource policy, and a transaction failure policy. The computer determines if sufficient computer resources are available to complete the transaction request based on the received information identifying resource requirements for the transaction. If there are not sufficient computer resources available to complete the transaction request, the computer applies the resource policy to the transaction request and processes the transaction request. If the processed transaction request fails to complete successfully, the computer applies the transaction failure policy to the processed transaction request.

### FIELD OF THE INVENTION

The present invention relates generally to transaction managers in transaction processing systems, and more particularly to a transaction manager that negotiates with a client for handling large transactions.

### BACKGROUND

Transaction processing is information processing that is divided into individual, indivisible operations, called transactions. Each transaction must succeed or fail as a complete unit, and cannot remain in an intermediate state. This is referred to as the atomicity requirement of a transaction. For example, a transaction that is a transfer of funds from one bank account to another consists of at least two separate operations: a debit of an amount from one account, and a credit of an equal amount to another account. If both operations do not occur, the transaction fails and the books of the bank will be left in an inconsistent state.

A transaction processing system is a type of information system that performs transactions on data in such a way as to ensure the data is in a consistent state after a transaction is processed. For example, a transaction processing system might receive the funds transfer transaction described above, and manage the processing of this transaction to ensure that the data, for example, the bank's books, are in a consistent state after the transaction has completed. In particular, the transaction processing system ensures the data is in a consistent state even if the transaction fails. For example, if the debit operation of the funds transfer transaction has occurred, but the credit operation is interrupted due to, for example, a communications network problem, the transaction processing system would back out the debit operation to maintain data consistency, and report the transaction failure. This example illustrates the basic concepts of maintaining data consistency. The complexity of maintaining data consistency rises quickly with the complexity of the computing environment, for example, an environment involving multiple databases distributed among several computers, and the complexity of the transactions and the data itself.

When a transaction processing system receives a transaction, the system does not know beforehand the resources required to complete the transaction. These resources can include storage to hold log files required to roll back failed transactions, storage to grow databases, storage to hold created reports, workspace storage to hold intermediate structures required to complete the transaction, memory required to complete the transaction, etc. If a transaction processing system depletes system resources, this may impact the immediate transaction by causing the transaction to fail, and can also impact other transactions in the transaction processing system, and possibly other users of the computer on which the transaction processing system resides.

Transaction processing system tools exist to allow a user to obtain estimates of certain resources used in a transaction. For example, the DB2 database software by International Business Machines Corporation includes an “Explain” feature that can provide resource usage estimates of a database query plan prior to execution of the plan. DB2 is a registered trademark of International Business Machines Corporation. Based on the resource usage estimate, a user might redesign the transaction to use less resources, or cancel the transaction entirely. The resource usage estimate provided by the DB2 Explain function is limited to an estimate of resources for DB2 only and does not address additional resources that may be required by a transaction processing system in which a DB2 database is only one component.

### SUMMARY

Embodiments of the present invention provide a system, method, and program product for handling transactions in a transaction processing system. A computer receives a transaction request that includes information identifying computer resource requirements for the transaction, a resource policy, and a transaction failure policy. The computer determines if sufficient computer resources are available to complete the transaction request based on the received information identifying resource requirements for the transaction request. If it is determined that there are not sufficient computer resources available to complete the transaction request, the computer applies the resource policy to the transaction request and processes the transaction request. If the processed transaction request fails to complete successfully, the computer applies the transaction failure policy to the processed transaction request.

In certain embodiments, the resource policy includes at least one of the following: the computer cancelling the requested request and reporting a transaction failure; the computer processing the transaction request regardless of whether the computer has determined that there are insufficient computer resources available to complete the transaction request; and the computer dividing the transaction request into a plurality of transaction requests, and processing each of the plurality of transaction requests.

In certain embodiments, the transaction includes a plurality of transaction input records, the transaction input records processed serially, and the transaction failure policy comprises at least one of the following: the computer backing out of the database all database changes caused by processing a failed transaction request; the computer updating the database with database changes caused by serially processing the transaction input records until the transaction fails; and the computer updating the database with database changes caused by serially processing the transaction input records until the transaction fails, and continuing to serially process transaction input records and update the database with database changes caused by serially processing transaction input records.

### BRIEF DESCRIPTION OF THE SEVERAL VIEWS OF THE DRAWINGS

FIG. 1 is a functional block diagram of a transaction system in accordance with embodiments of the present invention.

FIG. 2 is a flowchart illustrating the steps of a transaction manager in accordance with an embodiment of the present invention.

FIG. 3 is a block diagram of hardware and software within a computer in accordance with an embodiment of the present invention.

### DETAILED DESCRIPTION

The knowledge of the resource requirements for a particular transaction or set of transactions typically exists in two places: the transaction manager, which is a component of a transaction processing system that manages the resources required to implement transactional control and logging; and the client, which in general may be a person or a system component, that has knowledge of the complexity and other aspects of the desired transactional work. The transaction manager traditionally gains knowledge of the transaction requirements after the fact, while the client may have such knowledge before the transaction is submitted to the transaction processing system.

Embodiments of the invention are directed to a mechanism to enable transactional clients to communicate transaction resource requirements to a transaction manager, and negotiate over how a transaction can be successfully processed if there is a high likelihood that there are insufficient resources to complete the transaction as submitted. In this manner, the incidence of failed transactions can be reduced. For example, a client informed by the transaction processing system that a transaction is destined to fail due to insufficient system resources may have several options depending on the nature of the transaction. The client might allow the transaction to continue in the hope that it will complete successfully. The client might direct the transaction processing system to complete as much of the transaction as possible and report the final progress. For example, a large record insert transaction might be structured so that continuing to the point of resource depletion and transaction failure, followed by a commit operation, will not have any negative effects on the consistency of the database. The client might also direct the transaction processing system to break the transaction into more manageable “chunks.” For example, if a record insert transaction involves inserting 200,000 records into a database, the client might direct the system to insert 25,000 records at a time.

Embodiments of the present invention will now be described in detail with reference to the accompanying drawings.

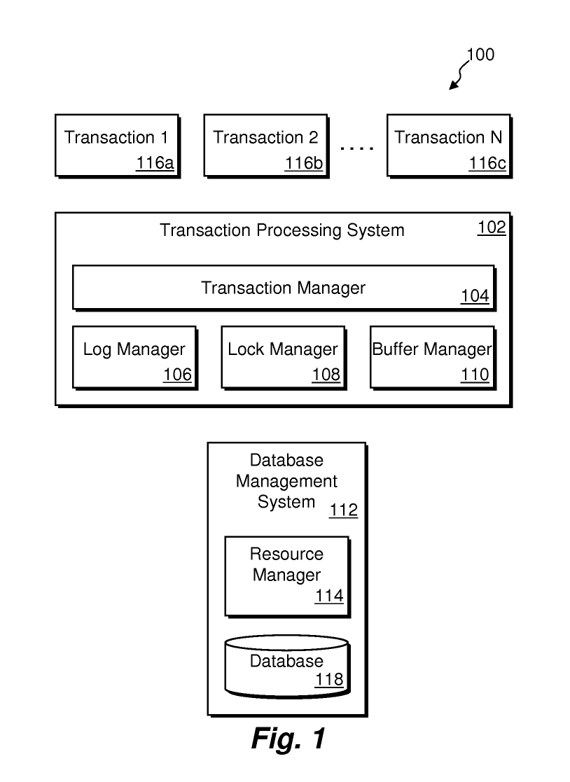

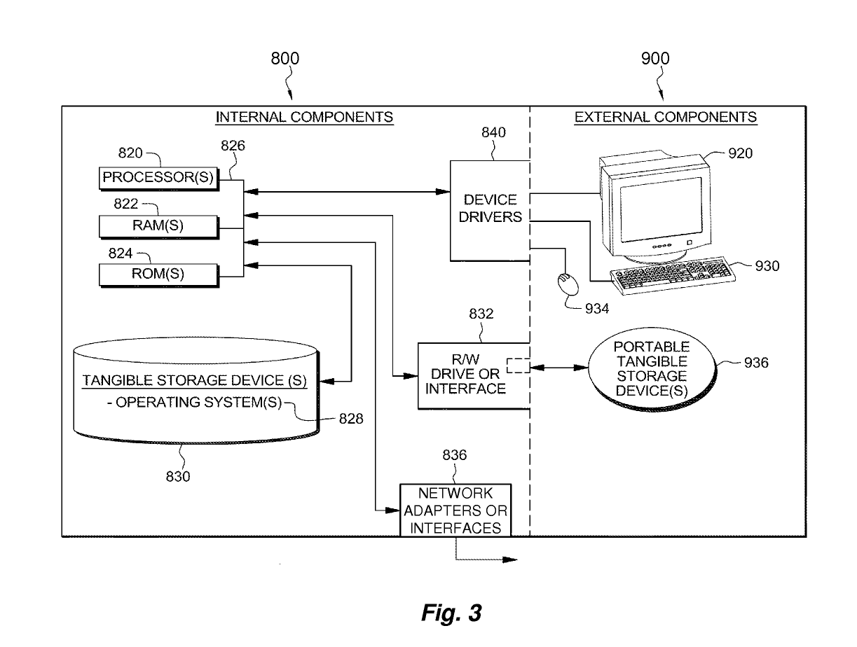

FIG. 1 is a functional block diagram illustrating a transaction system 100 in accordance with an embodiment of the present invention. Transaction system 100 includes one or more database transactions 116, transaction processing system 102, and database management system 112. Transaction system 100 typically executes on a computing device such as a laptop computer, a desktop computer, or a mainframe computer. However, transaction system 100 may operate in a distributed environment in which transaction processing system 102 and database management system 112 are implemented across a plurality of computing devices that communicate over a network, such as a local area network (LAN) or a wide area network (WAN) such as the Internet. In general, transaction system 100 can execute on any computing device satisfying specific implementation requirements, and as described in relation to FIG. 3.

In a preferred embodiment, transactions 116 represent transactions resulting from a client request to perform one or more actions on the information in database management system 112. A transaction can be a simple read of a database value, or a complex set of operations involving multiple related updates to information values across distributed computer systems. In embodiments of the present invention, there is an atomicity requirement for each transaction processed by transaction processing system 102. However, as will be discussed further below, the transaction as submitted can be modified before processing, and the atomicity requirement might not be so strict in every case that a transaction failure requires a rollback of the entire transaction.

Transaction processing system 102 includes the following programs: transaction manager 104, log manager 106, lock manager 108, and buffer manager 110. Transaction manager 104 manages the processes that execute a transaction and the processes to back out any completed database updates that may have occurred if a transaction fails. Transaction manager 104, among other activities, operates to manage all transactions so as to maintain data consistency. This is accomplished through use of log manager 106. Transaction manager 104 assigns each transaction a transaction ID, and log manager 106 records each operation associated with a transaction ID. If a transaction fails, processing on the data is halted, and transaction manager 104 uses the log data associated with the transaction to roll back all changes to the data resulting from any completed transaction operations. Log manager 106 typically records log data into memory buffers, then into a disk file. One possible manner in which a transaction can fail is if no more buffer space or disk space is available to the log file, forcing transaction manager 104 to abort and roll back all active transactions.

Buffer manager 110 operates in conjunction with database management system 112 to update database pages on disk, and to manage the buffer cache in computer memory to reduce database file I/O operations. Buffer manager 110 manages the functions for reading data or index pages from the database files into the buffer cache and writing modified pages back to the database. A page remains in the buffer cache until the buffer manager needs the buffer area to read in more data. Data is written back to disk only if it is modified. One possible manner in which a transaction can fail is if no more buffer space or disk space is available to buffer manager 110. This may happen, for example, in complex transactions in large databases.

Transaction manager 104 also operates to allocate memory space for use by a transaction to store, for example, intermediate data indexes, tables, and report structures that may be required for a transaction to complete. If there is insufficient memory, this may cause the transaction to fail.

Lock manager 108 operates to provide a mechanism to control concurrent access to database objects. For example, if a process transaction intends to update a record value in a database, lock manager 108 “locks” the database object to prevent other transactions from updating, and possibly reading, the same value until processing for the updating transaction has completed. If two transactions are both requesting read only access to a database object, lock manager 108 may allow both transactions access to the database object.

Database management system 112 includes resource manager 114 and associated database 118. Resource manager 114 manages access to database 118, and manages the resources associated with database 118, such as disk space. In embodiments of the invention, record updates to database 118 are handled through requests from transaction processing system 102 to resource manager 114. Higher level functions associated with maintaining database consistency are managed by transaction manager 104. One possible manner in which a transaction can fail is if resources available to databases 118, such as disk space, are depleted.

Transaction system 100 illustrates one example of the basic functional blocks of a transaction system. Other models for a transaction system are available that describe transaction systems in greater or lesser granularity and with different functional boundaries between functional blocks. These other descriptive models can be used equally as well, mutatis mutandis. In practice, transaction processing system 102 and database management system 112 are typically implemented as commercially available or open source software packages. Examples of commercially available transaction processing systems in accordance with embodiments of the present invention include the CICS (Customer Information Control System) Transaction Server family of mainframe transaction processing systems by International Business Machines Corporation, and SQL Server 2008 by Microsoft Corporation. CICS is a registered trademark of International Business Machines Corporation; SQL Server is a registered trademark of Microsoft Corporation. Examples of commercially available database management systems in accordance with embodiments of the present invention include the DB2 database software by International Business Machines Corporation, and SQL database software available from Microsoft Corporation.

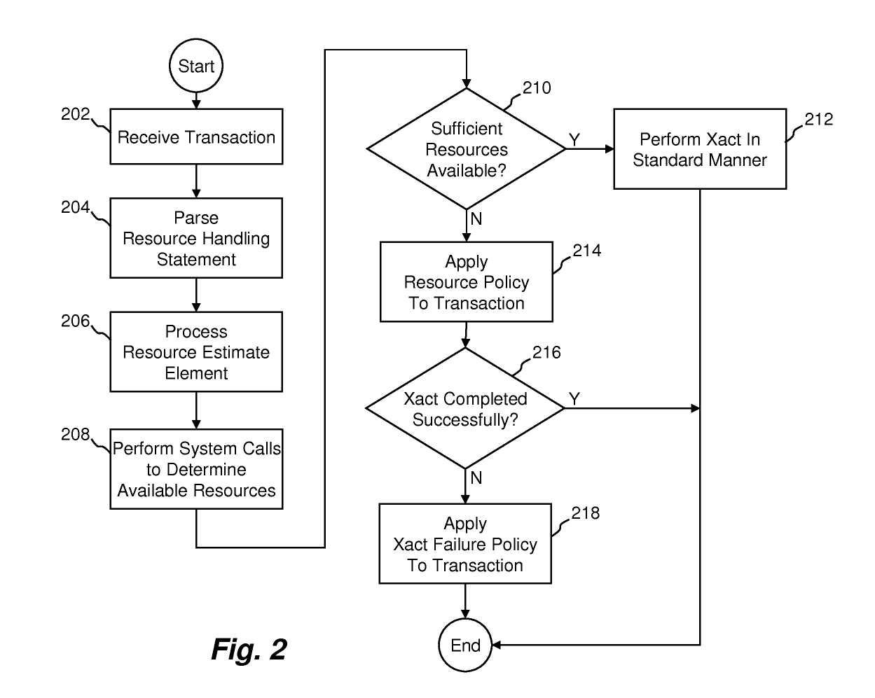

FIG. 2 is a flowchart illustrating steps that transaction manager 104 takes in accordance with an embodiment of the present invention. In a preferred embodiment of the invention, a transaction 116 submitted to transaction processing system 102 is received by transaction manager 104 (step 202). The transaction includes a resource handling statement that allows transaction manager 104 to estimate the amount of resources the transaction is expected to use. The transaction also includes a resource policy that directs transaction manager 104 how to proceed with the transaction if the transaction as submitted has a high likelihood of failure because the expected resource usage may exceed one or more available resources, and a transaction failure policy that directs the transaction manager how to proceed with the transaction if the transaction ultimately fails. In a preferred embodiment, the format of the resource handling statement can be as follows:

Resource.Handling resource-estimate, resource-policy, failure-policy;

At step 204, transaction manager 104 parses the resource handling statement. At step 206, transaction manager 104 processes the resource estimate from the resource handling statement. The resource estimate element of the resource handling statement allows the client to specify specific resources the transaction is expected to need, or is an address variable pointing to a defined program data block or to a file containing expected resource usage information. Information on the resources a specific transaction is expected to need can be obtained, for example, from previous executions of the transaction. Many transaction processing systems provide tools a client can utilize to obtain an estimate of resources required by a transaction without actually running the transaction. For example, as mentioned above, the DB2 query plan Explain function can provide limited analysis of a transaction before it is executed and provide a report that includes an estimate of database resource usage. The resource estimate element can include, for example, the file name of such a resource usage report. In embodiments of the invention, specific resource requirements can be included in the resource estimate element. For example, if a transaction requires large amounts of disk space, this might be specified by including an element such as Disk.Req=1500 in the resource handling statement. This element would inform transaction manager 104 that the transaction requires, for example, a total maximum disk space of 150 gigabytes during processing.

At step 208, transaction manager 104 makes one or more system calls to determine the availability of the system resources referenced in the resource estimate element. For example, if the resource estimate element includes the example from above, Disk.Req=1500, transaction manager 104 makes a system call requesting the appropriate disk free space to determine if sufficient resources are available. If the resource estimate element points to a report file or a program data block that specifies the expected transaction requirements for several system resources, transaction manager 104 makes a series of system calls to determine that sufficient resources for each system resource specified in the report file or data block is available to the transaction.

At decision step 210, transaction manager 104 determines if all specified transaction resource requirements can be met. If transaction manager 104 determines that all specified transaction resource requirements can be met, then transaction manager 104 executes the transaction in the default manner at step 212, and ends processing related to the resource handling statement.

If transaction manager 104 determines that one or more specified transaction resource requirements cannot be met, then at step 214 transaction manager 104 applies the resource policy specified in the resource handling statement. The resource policy element of the resource handling statement directs transaction manager 104 how to proceed with the transaction if the transaction as submitted has a high likelihood of failure because the expected resource usage may exceed one or more available resources. The resource policy actions are initiated based on the likelihood of transaction failure. For example, an assumption can be made that certain transaction resource estimates have a leeway of 20%, and the resource policy won't be executed until the estimate of the resource usage is at 80% of available resources. In embodiments of the invention, the resource policy actions are implemented, for example, as procedure calls, subroutines, or annotations to the transaction statements themselves.

Some examples of resource policies are as follows:
Cancel: Cancel the transaction and report failure to client.
Proceed: Proceed with the transaction regardless of resource determination.
Break(NNNNN): Break the transaction into a series of smaller transaction of NNNNN records, if the estimated log or storage utilization is greater than 80%.
   The resource policies can be applied at different levels of a transaction, for example, at the connection level, to a single transaction statement, or to a group of transaction statements.

The Cancel and Proceed policies, as their names suggest, direct transaction manager 104 to either cancel the transaction or proceed with the transaction even if transaction manager 104 has determined that it is likely that the transaction will fail due to one or more insufficient resources. The Break(NNNNN) policy directs transaction manager 104 to break the transaction into chunks of records. For example, if the transaction as submitted is a record insert operation of 200,000 records, the client might specify that the transaction can be broken into several smaller operations of 25,000 records each by including a Break(25000) resource policy. In this case, although there are 200,000 records to add to database 118, the client may determine that the records do not have to be inserted as a single transaction, and can be inserted in smaller batches. Thus, if transaction manager 104 determines at step 210 that the transaction is likely to fail because of one or more insufficient resources, transaction manager 104 can, for example, process batches of 25,000 records and perform a commit operations until all 200,000 records are inserted into database 118. While only a few examples of resource policies are presented, those skilled in the art will recognize that the possible resource policies are virtually limitless, and resource policies can be developed and tailored to handle almost any situation or eventuality.

At decision step 216, transaction manager 104 determines if the transaction, with specified resource policies applied, completed successfully. If transaction manager 104 determines that the transaction did complete successfully, then processing on the transaction ends. If transaction manager 104 determines that the transaction did not complete successfully, then at step 218, the transaction manager applies the transaction failure policy to the transaction. The transaction failure policy actions are initiated when transaction manager 104 detects a transaction failure. In embodiments of the invention, the transaction failure policy actions are implemented, for example, as procedure calls, subroutines, or annotations to the transaction statements themselves. Some examples of transaction failure policies are as follows:
Rollback: If the transaction fails, perform a rollback, report failure to client.
CommitPartialFail: If the transaction fails, update database with records processed up to the failure, report progress and failure point to client.
CommitPartialCont: If the transaction fails, update database with records processed up to the failure, then continue the update operation, committing changes prior to exhausting any resources until all records are processed.

The Rollback policy directs transaction manager 104 to perform a complete rollback of any unsuccessful transaction. For example, if the transaction was the 200,000 record insert transaction from above, a failure may have occurred during one of the 25,000 record insert transactions. In this case, the rollback policy would only back out that portion of the current 25,000 insert transaction that had not yet been committed.

The CommitPartialFail policy directs transaction manager 104 to perform a commit on the records processed up to the point of transaction failure. For example, if the transaction was the 200,000 record insert operation, the client can specify the Proceed policy for the resource policy, indicating that transaction manager 104 should proceed with the transaction even if it is determined that there may not be sufficient resources to successfully complete the transaction. If the transaction failed after partial completion, specifying the CommitPartialFail policy would direct transaction manager 104 to commit the insert records that were processed prior to the transaction failure, to back out any partially completed records, and to report to the client the status of the database and the transaction.

The CommitPartialCont policy directs transaction manager 104 to perform a commit on the records processed up to the point of transaction failure, and to continue with update and commit operations until all records are processed. It is assumed in this case that performing the commit operation will in itself free up resources, for example log file space, whose depletion may have contributed the transaction failure.

In certain embodiments of the invention, a policy set specifying a hierarchy of resource failure policies can be specified such that if the first specified policy causes a transaction to fail because of a resource shortage, the second policy will be invoked. For example, the following policy set may be specified or referenced in the failure-policy element of the Resource.Handling statement:
Policy_{—}1: Commit all;
Policy_{—}2: Commit all updates, then commit 10000 rows at a time;
Policy_{—}3: Commit all updates, then commit 1000 rows at a time; Policy_{—}4: Commit all updates, then commit one row at a time;
   This policy set directs transaction manager 104 to attempt to complete the requested transaction following each transaction failure by performing update and commit operations on ever smaller numbers of transaction records, with Policy_{—}4 indicating to attempt to complete the transaction by performing update and commit operations on one record at a time. Such a policy set may cause program control to return to step 214 or step 216, depending on the specifics of the policy.

While only a few examples of transaction failure policies are presented, those skilled in the art will recognize that the possible policies is virtually limitless, and policies can be developed and tailored to handle almost any situation or eventuality.

Because a primary goal of any transaction processing system 102 is data consistency, it is expected that the transaction failure policies will be designed such that if the policy cannot be successfully applied after a transaction failure, a fallback policy will be executed to ensure data consistency. For example, if the transaction failure policy cannot be successfully applied, the fallback policy can be the standard system policy of complete rollback of the transaction as submitted.

After transaction manager 104 has applied the transaction failure policy to the unsuccessful transaction at step 218, processing ends for the transaction.

FIG. 3 shows a block diagram of the components of a data processing system 800, 900, such as such as a laptop computer, a desktop computer, or a mainframe computer, on which transaction system 100 operates in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Data processing system 800, 900 includes internal components 800 and external components 900 as illustrated in FIG. 3. Internal components 800 include one or more processors 820, one or more computer-readable RAMs 822 and one or more computer-readable ROMs 824 on one or more buses 826, and one or more operating systems 828 and one or more computer-readable tangible storage devices 830. Operating system 828 and programs 102, 104, 106, 108, 110, and 112 are stored on computer-readable tangible storage device 830 for execution by processor 820 via RAM 822 (which typically include cache memory). In the embodiment illustrated in FIG. 3, computer-readable tangible storage device 830 is a magnetic disk storage device of an internal hard drive. Alternatively, computer-readable tangible storage device 830 is a semiconductor storage device such as ROM 824, EPROM, flash memory or any other computer-readable tangible storage device that can store a computer program and digital information.

Internal components 800 also includes a Read/Write drive or interface 832 to read from and write to one or more portable computer-readable tangible storage devices 936 such as a CD-ROM, DVD, memory stick, magnetic tape, magnetic disk, optical disk or semiconductor storage device. The programs 102, 104, 106, 108, 110, and 112 can be stored on computer-readable tangible storage device 936, read via Read/Write drive or interface 832 and loaded into hard drive 830.

Internal components 800 also include network adapters or interfaces 836 such as a TCP/IP adapter cards, wireless wi-fi interface cards, or 3G or 4G wireless interface cards or other wired or wireless communication links. The programs 102, 104, 106, 108, 110, and 112 can be downloaded computing device 800, 900 from an external computer via a network (for example, the Internet, a local area network or other, wide area network) and network adapters or interfaces 836. From the network adapters or interfaces 836, the programs 102, 104, 106, 108, 110, and 112 are loaded onto hard drive 830. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 also includes device drivers 840 to interface to computer display monitor 920, keyboard 930 and computer mouse 934. The device drivers 840, Read/Write drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method for handling transactions in a transaction processing system, the method comprising the steps of:
a computer receiving a transaction request that includes information identifying computer resource requirements for the transaction, a resource policy, and a transaction failure policy;
the computer determining if sufficient computer resources are available to complete the transaction request based on the received information identifying computer resource requirements for the transaction request;
in response to determining that sufficient computer resources are not available to complete the transaction request, the computer applying the resource policy to the transaction request and processing the transaction request;
the computer determining if the processed transaction request failed to complete successfully; and
in response to determining that the processed transaction request failed to complete successfully, the computer applying the transaction failure policy to the processed transaction request.

2. A method in accordance with claim 1, wherein the step of applying the resource policy comprises at least one of:
the computer cancelling the transaction request and reporting a transaction failure;
the computer processing the transaction request regardless of whether the computer has determined that there are insufficient computer resources available to complete the transaction request; and
the computer dividing the transaction request into a plurality of transaction requests, and processing each of the plurality of transaction requests.

3. A method in accordance with claim 1, the transaction including a plurality of transaction input records, the transaction input records processed serially, wherein the step of applying the transaction failure policy comprises at least one of:
the computer backing out of the database all database changes caused by processing a failed transaction request;
the computer updating the database with database changes caused by serially processing the plurality of transaction input records until the transaction request fails; and
the computer updating the database with database changes caused by serially processing the plurality of transaction input records until the transaction fails, and continuing to serially process the plurality of transaction input records and update the database with database changes caused by serially processing the plurality of transaction input records.

4. A computer program product for handling transactions in a transaction processing system, the computer program product comprising:
one or more computer-readable storage devices and program instructions stored on at least one of the one or more tangible storage devices, the program instructions comprising:
program instructions to receive a transaction request that includes information identifying computer resource requirements for the transaction, a resource policy, and a transaction failure policy;
program instructions to determine if sufficient computer resources are available to complete the requested request based on the received information identifying computer resource requirements for the transaction request;
program instructions, in response to determining that sufficient computer resources are not available to complete the transaction request, to apply the resource policy to the transaction request and processing the transaction request;
program instructions to determine if the processed transaction request failed to complete successfully; and
program instructions, in response to determining that the processed transaction request failed to complete successfully, to apply the transaction failure policy to the processed transaction request.

5. A computer program product in accordance with claim 4, wherein the program instructions to apply the resource policy comprises at least one of:
program instructions to cancel the transaction request and to report a transaction failure;
program instructions to process the transaction request regardless of whether the computer has determined that there are insufficient computer resources available to complete the transaction request; and
program instructions to divide the transaction request into a plurality of transaction requests, and process each of the plurality of transaction requests.

6. A computer program product in accordance with claim 4, the large transaction including a plurality of transaction input records, the transaction input records being processed serially, wherein the program instructions to apply the transaction failure policy comprises at least one of:
program instructions to back out of the database all database changes caused by processing a failed transaction request;
program instructions to update the database with database changes caused by serially processing the plurality of transaction input records until the transaction request fails; and
program instructions to update the database with database changes caused by serially processing the plurality of transaction input records until the transaction fails, and continuing to serially process the plurality of transaction input records and update the database with database changes caused by serially processing the plurality of transaction input records.

7. A computer system to handle transactions in a transaction processing system, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a transaction request that includes information identifying computer resource requirements for the transaction, a resource policy, and a transaction failure policy;
program instructions to determine if sufficient computer resources are available to complete the transaction request based on the received information identifying resource requirements for the transaction request;
program instructions, in response to determining that sufficient computer resources are not available to complete the transaction request, to apply the resource policy to the transaction request and processing the transaction request;
program instructions to determine if the processed transaction request failed to complete successfully; and
program instructions, in response to determining that the processed transaction request failed to complete successfully, to apply the transaction failure policy to the processed transaction request.

8. A computer system in accordance with claim 7, wherein the program instructions to apply the resource policy comprises at least one of:
program instructions to cancel the transaction request and to report a transaction failure;
program instructions to process the transaction request regardless of whether the computer has determined that there are insufficient computer resources available to complete the transaction request; and
program instructions to divide the transaction request into a plurality of transaction requests, and process each of the plurality of transaction requests.

9. A computer system in accordance with claim 7, the transaction including a plurality of transaction input records, the transaction input records processed serially, wherein the program instructions to apply the transaction failure policy comprises at least one of:
program instructions to back out of the database all database changes caused by processing a failed transaction request;
program instructions to update the database with database changes caused by serially processing the plurality of transaction input records until the transaction request fails; and
program instructions to update the database with database changes caused by serially processing the plurality of transaction input records until the transaction request fails, and continuing to serially process the plurality of transaction input records and update the database with database changes caused by serially processing the plurality of transaction input records.
